(19) United States
(12) Patent Application Publication
(10) Pub. No.: US 2025/0284872 A1
(43) Pub. Date: Sep. 11, 2025

(54) CELL LAYOUT GENERATION DEVICE FOR IC DESIGN, SYSTEM AND METHOD USING THE SAME

(71) Applicant: AXION Co., Ltd., Seongnam-si (KR)

(72) Inventors: Kee Sup KIM, El Dorado Hills, CA (US); Younggwang JUNG, Incheon (KR); Juho LEE, Seoul (KR); Jiwoo NAM, Seoul (KR)

(21) Appl. No.: 19/075,479

(22) Filed: Mar. 10, 2025

Related U.S. Application Data
(60) Provisional application No. 63/563,381, filed on Mar. 10, 2024.

(51) Int. Cl. G06F 30/392; G06F 119/22

(52) U.S. Cl. CPC G06F 30/392; G06F 2119/22

(57) ABSTRACT

The present disclosure relates to a cell layout generation device for integrated circuit design, a system including the same, and a method using the same, and more particularly, to a cell layout generation device for integrated circuit design, a system including the same, and a method using the same, wherein the cell layout generation device includes a cell layout generator configured to determine a placement corresponding to at least one transistor according to a predefined criterion based on data input to generate at least one cell layout, and generate the at least one cell layout by determining a routing corresponding to the placement, wherein the predefined criterion is a process and device-friendly design condition in which semiconductor manufacturing process characteristics and device characteristics are taken into account.

### CROSS-REFERENCE TO RELATED APPLICATION(S)

This application claims priority under 35 USC 119 to U.S. Provisional Application No. 63/563,381, filed on Mar. 10, 2024, the contents of which is incorporated herein by reference in its entirety.

### FIELD OF THE DISCLOSURE

The present disclosure relates to a cell layout generation device for integrated circuit design, a system including the same, and a method using the same.

### BACKGROUND OF THE RELATED ART

Electronic design automation (hereinafter, ‘EDA’) refers to a category of software tools used to design electronic systems, particularly, integrated circuits (ICs). Using the EDA, a chip designer may design and analyze a semiconductor chip that may contain billions of components.

To effectively design ICs using the EDA, a cell library is essential. However, most existing cell libraries have been constructed after a cell layout is manually generated. Thus, there is a problem in that automated cell layout generation is difficult.

In addition, since it is difficult to perform designing by taking a yield into account in a general IC design process, a designer may not check the yield at a design stage until an actual chip is implemented. Accordingly, there is a problem in that a yield change according to a cell change cannot be checked.

### SUMMARY OF THE INVENTION

### Technical Problems

Accordingly, the present disclosure has been made in view of the above-mentioned problems occurring in the related art, and it is an object of the present disclosure to provide a cell layout generation device for integrated circuit (IC) design, a system including the same, a method using the same, the cell layout generation device being capable of automatically generating a cell layout for IC design and optimizing the cell layout using an optimization engine.

In particular, an object of the present disclosure is to provide a cell layout generation device for IC design, a system including the same, and a method using the same, the cell layout generation device being capable of automatically generating a cell layout in consideration of a process and device-friendly design condition in which semiconductor manufacturing process characteristics and device characteristics are taken into account, and by optimizing a yield of the generated cell layout to satisfy a target yield, generating a cell layout in which an optimum yield is take into account.

In addition, an object of the present disclosure is to provide a cell layout generation device for IC design, a system including the same, and a method using the same, the cell layout generation device being capable of generating a high-yield cell library including a cell layout in which an optimal yield is taken into account, and verifying a yield improvement by the generated high-yield cell library.

However, objects of the present disclosure are not limited to the objects described above, and other objects may be understood based on the following description.

### Technical Solution

To accomplish the above-mentioned objects, according to one aspect of the present disclosure, there is provided a cell layout generation device for integrated circuit design, the cell layout generation device including a cell layout generator configured to determine a placement corresponding to at least one transistor according to a predefined criterion based on data input to generate a cell layout, and generate at least one cell layout by determining a routing corresponding to the determined placement, wherein the predefined criterion may be a process and device-friendly design condition in which semiconductor manufacturing process characteristics and device characteristics are taken into account.

To accomplish the above-mentioned objects, according to one aspect of the present disclosure, there is provided a cell layout generation device for integrated circuit design, the cell layout generation device including: a cell layout generator configured to determine a placement corresponding to at least one transistor according to a predefined criterion based on data input to generate a cell layout, and generate a cell layout by determining a routing corresponding to the determined placement; and an optimization engine configured to derive an optimization parameter for a yield of the generated cell layout using a yield optimization model provided in advance, wherein the predefined criterion may be a process and device-friendly design condition in which semiconductor manufacturing process characteristics and device characteristics are taken into account, and the cell layout generator may generate a yield-optimized cell layout that satisfies a preset target yield by changing the generated cell layout according to the optimization parameter derived from the optimization engine.

To accomplish the above-mentioned objects, according to one aspect of the present disclosure, there is provided an integrated circuit design system including: a cell layout generation device including a cell layout generator configured to determine a placement corresponding to at least one transistor according to a predefined criterion based on data input to generate a cell layout and generate a cell layout by determining a routing corresponding to the determined placement, and an optimization engine configured to derive an optimization parameter for a yield of the generated cell layout using a yield optimization model provided in advance, and configured to generate a high-yield cell library; and a verification device configured to verify a yield improvement by the high-yield cell library generated by the cell layout generation device, wherein the predefined criterion may be a process and device-friendly design condition in which semiconductor manufacturing process characteristics and device characteristics are taken into account.

To accomplish the above-mentioned objects, according to one aspect of the present disclosure, there is provided a method performed by a cell layout generation device for integrated circuit design, the method including: determining a placement corresponding to at least one transistor according to a predefined criterion based on data input to generate a cell layout; and generating at least one cell layout by determining a routing corresponding to the determined placement, wherein the predefined criterion may be a process and device-friendly design condition in which semiconductor manufacturing process characteristics and device characteristics are taken into account.

To accomplish the above-mentioned objects, according to one aspect of the present disclosure, there is provided a method performed by a cell layout generation device for integrated circuit design, the method including: a cell layout generation operation for determining a placement corresponding to at least one transistor according to a predefined criterion based on data input to generate a cell layout, and generating a cell layout by determining a routing corresponding to the determined placement; an optimization parameter derivation operation of deriving an optimization parameter for a yield of the generated cell layout using a yield optimization model provided in advance; and an optimization operation for generating a yield-optimized cell layout that satisfies a preset target yield by changing the generated cell layout according to the derived optimization parameter, wherein the predefined criterion may be a process and device-friendly design condition in which semiconductor manufacturing process characteristics and device characteristics are taken into account.

To accomplish the above-mentioned objects, according to one aspect of the present disclosure, there is provided a method performed by an integrated circuit design system, the method including: determining a placement corresponding to at least one transistor according to a predefined criterion based on data input to generate a cell layout, and generating a cell layout by determining a routing corresponding to the determined placement; deriving an optimization parameter for a yield of the generated cell layout using a yield optimization model provided in advance; generating a yield-optimized cell layout that satisfies a preset target yield by changing the generated cell layout according to the derived optimization parameter; constructing a high-yield cell library including the generated yield-optimized cell layout; and verifying a yield improvement by the constructed high-yield cell library, wherein the predefined criterion may be a process and device-friendly design condition in which semiconductor manufacturing process characteristics and device characteristics are taken into account.

### Advantageous Effects

According to a cell layout generation device for integrated circuit design, a system including the same, and a method using the same, a cell layout may be automatically generated in consideration of a process and device-friendly design condition in which semiconductor manufacturing process characteristics and device characteristics are taken into account, and the generated cell layout may be optimized according to an optimization parameter derived by using an optimization engine to thereby generate an automatically yield-optimized cell layout without particular intervention by a designer and construct a high-yield cell library.

In addition, when the present disclosure is applied to an integrated circuit design system including a high-yield cell library, a yield improvement by a generated high-yield cell library may be verified.

Further, various effects other than the effects described above may be directly or implicitly disclosed in the detailed description according to an embodiment of the present disclosure to be described later.

### BRIEF DESCRIPTION OF THE DRAWINGS

FIG. 1 is a diagram illustrating an example for explaining an integrated circuit design system according to an embodiment of the present disclosure;

FIG. 2 is a diagram illustrating an example for explaining a high-yield cell library according to an embodiment of the present disclosure;

FIG. 3 is a block diagram illustrating main components of a cell layout generation device according to an embodiment of the present disclosure;

FIG. 4 is a flowchart for explaining an operation of the cell layout generation device according to an embodiment of the present disclosure;

FIGS. 5 to 6 are diagrams illustrating an example for briefly explaining operations of a placer and a router according to an embodiment of the present disclosure;

FIGS. 7 to 17 are diagrams illustrating an example for explaining a first embodiment of a placing process by the placer according to an embodiment of the present disclosure;

FIGS. 18 to 25 are diagrams illustrating examples for explaining a second embodiment of a placing process by the placer according to an embodiment of the present disclosure;

FIGS. 26 to 30 are diagrams illustrating examples for explaining a first embodiment of a routing process by the router according to an embodiment of the present disclosure;

FIGS. 31 and 32 are diagrams illustrating an example for explaining a second embodiment of the routing process by the router according to an embodiment of the present disclosure;

FIGS. 33 to 35 are diagrams illustrating an example for explaining operations of a placer and a router according to another embodiment of the present disclosure;

FIG. 36 is a block diagram illustrating main components a cell layout generation device according to another embodiment of the present disclosure;

FIG. 37 is a flowchart for explaining an operation of the cell layout generation device according to another embodiment of the present disclosure;

FIG. 38 is a diagram illustrating for explaining an operation of the cell layout generation device according to another embodiment of the present disclosure;

FIG. 39 is a flowchart for explaining an operation according to still another embodiment of the present disclosure; and

FIGS. 40 and 41 are diagrams illustrating an example for explaining an active folding process in the placer according to an embodiment of the present disclosure.

### DETAILED DESCRIPTION OF THE PREFERRED EMBODIMENT

Features and advantages of the technical solution of the present disclosure and methods of accomplishing the same may be understood more readily with reference to the following detailed description of particular embodiments of the present disclosure and the accompanying drawings.

However, certain detailed explanations of well-known functions relevant to the present disclosure are omitted when it is deemed that they may unnecessarily obscure the essence of the present disclosure. It should be noted that like reference numerals in the drawings denote like elements.

Hereinafter, terms or words used in the description and drawings should not be interpreted as being limited to have a general meaning or a meaning defined in a dictionary, but should be interpreted as having a meaning and a concept which are consistent with the technical ideas of the present disclosure, based on a principle such that an inventor may properly define concepts of the terms to explain the disclosure of the inventor by using an optimum method. Accordingly, it should be understood that embodiments in the specifications and configurations illustrated in drawings are only example embodiments, and there is no intent to limit the example embodiments to the particular forms disclosed, but on the contrary, example embodiments are to cover all modifications, equivalents, and alternatives falling within the scope of the present disclosure.

Additionally, when an element is referred to as being “connected” or “coupled” to another element, this means that the element may be logically or physically connected or coupled to the another element. In other words, it should be understood that the element may be directly connected or coupled to the another element, but intervening elements may be present or the element may be indirectly connected or coupled to the another element.

In addition, the terms used in the present specification are merely used to describe particular embodiments, and are not intended to limit the present disclosure. A singular representation may include a plural representation unless it represents a definitely different meaning from the context.

In addition, it is to be understood that the terms such as “including” or “having,” etc. described herein are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

The term “module” used in various embodiments herein may include a unit implemented in hardware, software or firmware, and may be used interchangeably with terms such as logic, logic block, component, or circuit.

In this specification, each component according to various embodiments (e.g., a module or a program) may contain one or more entities, and some of the entities may be separated and placed in other components. According to various embodiments, one or more of the aforementioned components or operations may be omitted, or one or more other components or operations may be added. Alternatively or additionally, a plurality of components (e.g. (modules or programs) may be integrated into a single component. In this case, the component resulting from the integration may perform one or more functions of each of the plurality of components identically or similarly to those performed by a corresponding component among the plurality of components before the integration.

According to various embodiments, operations performed by a module, program or other component may be performed sequentially, in parallel, iteratively, or heuristically, or one or more of the operations may be performed in a different order, omitted, or one or more other operations may be added.

Hereinafter, a cell layout generation device for integrated circuit (IC) design according to an embodiment of the present disclosure, a system including the same, and a method using the same are described with reference to the accompanying drawings.

First, an integrated circuit design system according to an embodiment of the present disclosure is described.

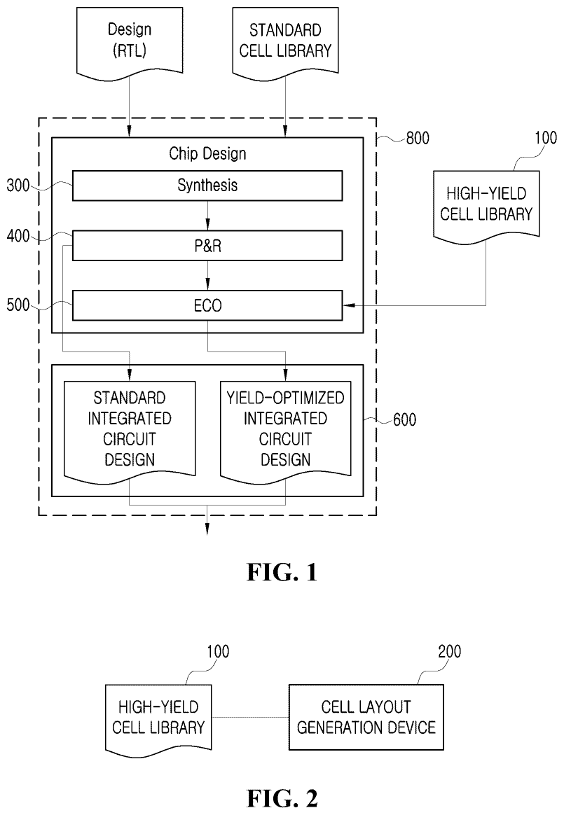

FIG. 1 is a diagram illustrating an example for explaining the integrated circuit design system according to an embodiment of the present disclosure. FIG. 2 is a diagram illustrating an example for explaining a high-yield cell library according to an embodiment of the present disclosure.

Referring to FIG. 1, the integrated circuit design system according to an embodiment of the present disclosure may be configured to include a cell layout generation device (not shown) configured to construct a high-yield cell library 100 and a verification device 800 capable of verifying a yield improvement of the high-yield cell library 100.

In detail, the verification device 800 according to an embodiment of the present disclosure desirably relates to a device that may be applied to an integrated circuit design system to verify a yield improvement. Whereas an integrated circuit design system in the related art merely generates a standard integrated circuit simply using a standard cell library, the integrated circuit design system including the verification device 800 according to an embodiment of the present disclosure may immediately guide, to a designer, a yield improvement according to application of the high-yield cell library 100. Thus, the yield improvement may be immediately checked.

The verification device 800 according to an embodiment of the present disclosure may verify a yield improvement made by a high-yield cell library by comparing degrees of yield improvements between an original integrated circuit design generated using a standard cell library and a yield-optimized integrated circuit design generated by applying the high-yield cell library 100. The verification device 800 may be configured to include a synthesis module 300 configured to perform an initial design according to design rules based on design data (register transfer level (RTL)) for generating an original integrated circuit design and the standard cell library, a placement & routing (P&R) module 400 configured to generate the original integrated circuit design by placing and routing cells based on the initial design, an engineering change order (ECO) module 500 configured to change the original integrated circuit design for functional modification of the generated original integrated circuit design, timing optimization, problem solving, etc., and in particular, to generate a yield-optimized integrated circuit design by applying the high-yield cell library 100 to the original integrated circuit design, and a multi-product wafer (MPW) module 600 capable of comparing degrees of yield improvements between the original integrated circuit design to the yield-optimized integrated circuit design, i.e., a design obtained by improving the original integrated circuit design, and immediately verifying and presenting the yield improvement by the high-yield cell library 100 to a designer.

As such, by using an integrated circuit system to which the verification device 800 according to an embodiment of the present disclosure is applied, an original integrated circuit design generated based on a standard cell library may be changed into a high-yield cell at an ECO stage by applying a criterion for design for manufacturability (DFM). Thus, a design objective of the designer may be easily achieved with minimal changes.

In addition, the high-yield cell library 100 according to an embodiment of the present disclosure may be pre-generated and constructed by a cell layout generation device 200 as illustrated in FIG. 2, and the constructed high-yield cell library 100 may be distributed to various integrated circuit design systems to facilitate a yield optimization process based on the design for manufacturing (DFM).

Hereinafter, the cell layout generation device 200 configured to construct the high-yield cell library 100 according to an embodiment of the present disclosure is described in detail.

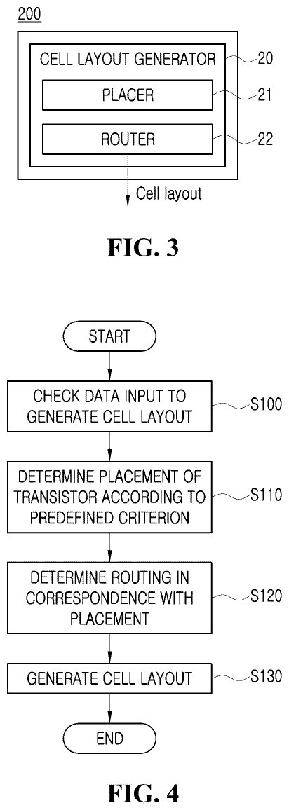

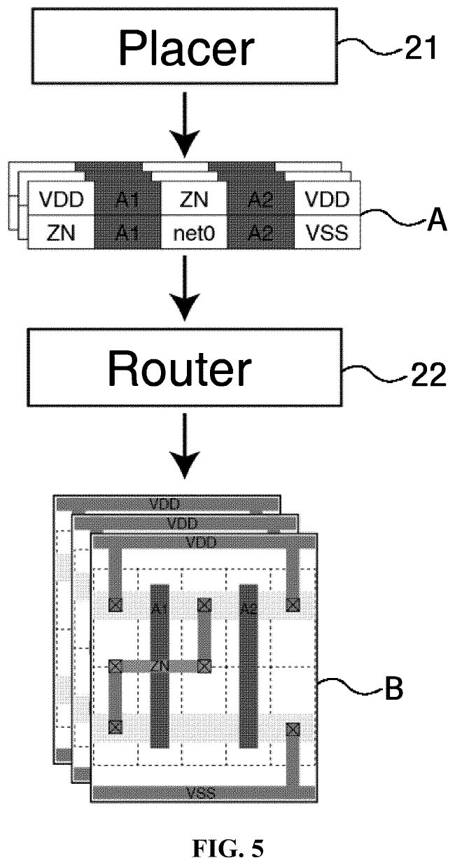

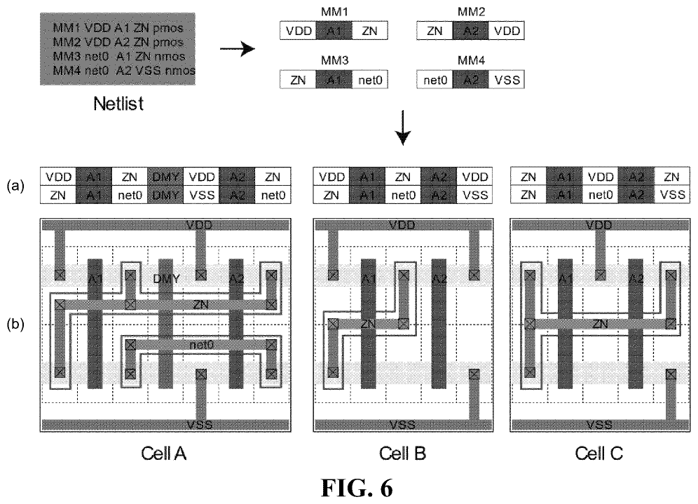

FIG. 3 is a block diagram illustrating main components of a cell layout generation device according to an embodiment of the present disclosure. FIG. 4 is a flowchart for explaining an operation of the cell layout generation device according to an embodiment of the present disclosure. FIGS. 5 and 6 are diagrams illustrating an example for briefly explaining operations of a placer and a router according to an embodiment of the present disclosure.

First, referring to FIGS. 3 and 4, the cell layout generation device 200 according to an embodiment of the present disclosure includes a cell layout generator 20. The cell layout generator 20 according to an embodiment of the present disclosure may perform a process of checking data input to generate a cell layout (S100), determining a placement corresponding to at least one transistor according to a predefined criterion based on the input data (S110), determining a routing corresponding to the determined placement (S120), and generating at least one cell layout (S130).

A cell at this time may be a standard cell which is a design block including a basic logic circuit, or a custom cell which is a design block optimized for a particular purpose. That is, the cell layout generation device 200 according to an embodiment of the present disclosure may generate the high-yield cell library 100 of FIG. 2 by generating a custom cell which is a yield-optimized design block, but may also generate a standard cell library with an improved yield, depending on an implementation method.

Meanwhile, the input data may include circuit information including electrical connection relationships between transistors constituting a circuit for a particular logic function and process information including constraints in which an integrated circuit design manufacturing process is taken into account. The circuit information and the process information may be data input by a user, i.e., a designer who intends to design an integrated circuit, or data input by a user who intends to construct and distribute the high-yield cell library 100, or data automatically loaded in a prestored state.

In detail, the circuit information according to an embodiment of the present disclosure may be circuit connection information, and may be, for example, a netlist in which transistors corresponding to a cell layout are connected, but is not limited thereto. The circuit information includes electrical connection relationships between transistors constituting a circuit, and may include electrical connection relationships regarding transistors constituting a circuit that performs a particular logic function (an AND gate, an OR gate, a flip-flop, etc.), e.g., transistor or pin connections, etc.

In detail, the process information according to an embodiment of the present disclosure may be process design information, e.g., a process design kit (PDK), but is not limited thereto. The process information may include constraints in which an integrated circuit design manufacturing process is taken into account, e.g., constraints on process rules for enabling to generate cells to correspond to a particular semiconductor process (e.g., 5 nm, 7 nm, 28 nm, etc.). At this time, the constraints may include physical constraints such as design rules, metal layer limitations, electrical characteristics of routings, or power integrity rules.

In particular, the process information according to an embodiment of the present disclosure may include a design condition based on a lithography process (a lithography friendly design). For example, optical and mask information for the lithography process may be included. At this time, the optical information according to an embodiment of the present disclosure may be optical information that may be applied when a pattern is formed on a wafer using light in a lithography process, and the mask information may be information related to a photomask used to transfer a semiconductor pattern onto a wafer. In addition, since a generally known process may be applied to the lithography process, a detailed description will not be provided here.

As described above, when data is input to generate a cell layout, the cell layout generator 20 in the present disclosure generates a cell layout based on the input data. Placement and routing of transistors are determined according to a predefined criterion (a process and device-friendly design condition in which semiconductor manufacturing process characteristics and device characteristics are taken into account).

The process and device-friendly design condition in which semiconductor manufacturing process characteristics and device characteristics are taken into account according to an embodiment of the present disclosure may mean a cell layout design condition designed to enable implementation such that process and device variations are minimized by taking into account semiconductor manufacturing process characteristics and device characteristics.

In particular, the semiconductor manufacturing process characteristics and the device characteristics according to an embodiment of the present disclosure may satisfy a lithography process condition among semiconductor manufacturing process conditions, but are not limited thereto.

In detail, the semiconductor manufacturing process characteristics and the device characteristics according to an embodiment of the present disclosure may be a transistor width, an active layer, a poly layer, a metal layer, locations and a number of contact areas, etc. which satisfy a lithography process-based condition, but are not limited thereto.

To generate a cell layout according to a predefined criterion based on input data, the cell layout generator 20 according to an embodiment of the present disclosure may be configured to include a placer 21 and a router 22 each configured to generate a cell layout.

With respect to a brief description of operations of the placer 21 and the router 22 according to an embodiment of the present disclosure with reference to FIGS. 5 and 6, the placer 21 may determine at least one placement applicable in correspondence with at least one transistor capable of performing a particular logic function based on input data, according to a predefined criterion.

Transistors (a p-channel metal-oxide semiconductor (PMOS) transistor or an n-channel metal-oxide semiconductor (NMOS) transistor) configured to perform a logic function (AND, OR, NOT, etc.) may be placed in one cell. The placer 21 according to an embodiment of the present disclosure may generate placement candidates for transistors applicable to configure a cell that implements the logic function. At this time, the placement candidates may be generated in an arrangement form A according to a placement order of the transistors. Then, the placer 21 in the present embodiment may determine at least one placement among all the placement candidates according to a predefined criterion.

As illustrated in FIG. 6 as an example, the placer 21 according to an embodiment of the present disclosure may identify four transistors MM1, MM2, MM3, and MM4 configured to perform particular logic functions based on data (netlist) input to generate a cell layout, and check an electrical connection relationship between the four transistors. In addition, as shown in (a), the placer 21 may generate possible placement candidates for the transistors. At this time, the placer 21 may evaluate all of the placement candidates using a predefined criterion including at least one element of a cell width, a wirelength, and a pin access, and determine a final placement.

Then, the router 22 according to an embodiment of the present disclosure generates one or more routing candidates B applicable in correspondence with the placement determined by the placer 21, as illustrated in FIG. 5, and determines at least one routing among all of the generated routing candidates according to a predefined criterion to generate a cell layout. The predefined criterion at this time may be design objectives derived from the input data, such as quantitative indices, e.g., performance, power, an area, a wirelength, etc. The router 22 according to an embodiment of the present disclosure may determine one routing candidate according to the predefined criterion.

In addition, the router 22 according to an embodiment of the present disclosure may finally generate any one desirable cell layout when each of cell layouts Cell A, Cell B, and Cell C is generated in correspondence with each placement as shown in FIG. 6. At this time, a cell layout may be also finally generated according to the predefined criterion.

The main components and operation of the cell layout generation device 200 according to an embodiment of the present disclosure have been briefly described above

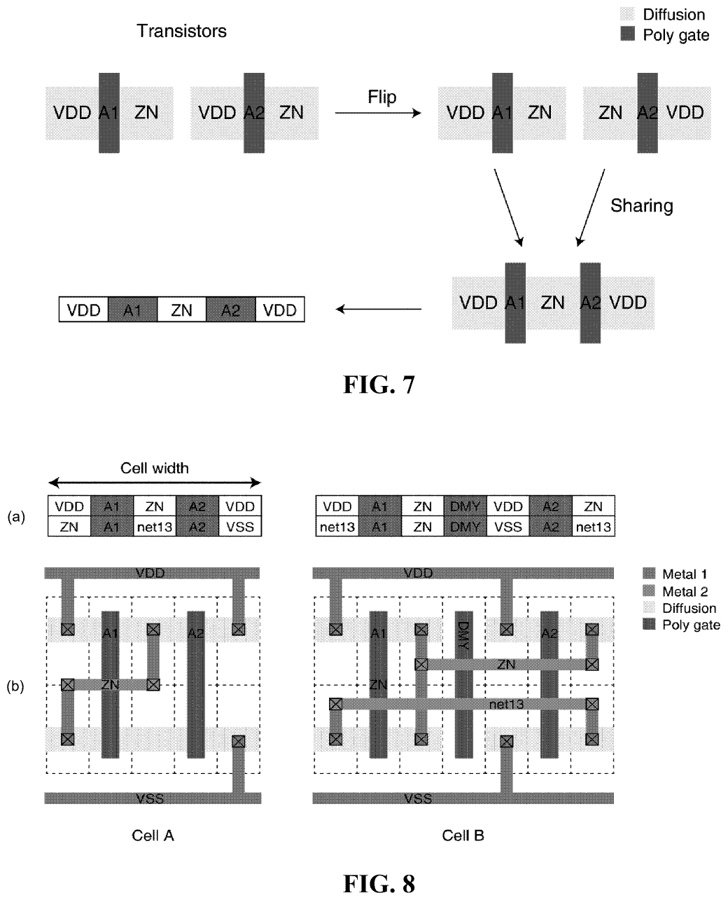

Hereinafter, referring to FIGS. 7 to 32, processes of performing placement and routing by the placer 21 and the router 22 according to an embodiment of the present disclosure are described in detail.

First, a placement process by the placer according to an embodiment of the present disclosure is to be described separately for a first embodiment and a second embodiment.

FIGS. 7 to 17 are diagrams illustrating an example for explaining a first embodiment of a placing process by the placer according to an embodiment of the present disclosure.

As described above, the placer 21 in the present embodiment may determine a placement of transistors based on input data. At this time, the placer 21 may place at least one transistor to implement a particular logic function defined in the input data (netlist and PDK). For example, when the placer 21 according to an embodiment of the present disclosure is to implement a NAND (Not AND) gate function, placement of PMOS transistors and NMOS transistors may be determined according to connection information checked through the netlist.

In particular, the placer 21 according to an embodiment of the present disclosure may generate all placement candidates applicable in correspondence with transistors in the process of placing the transistors as described above, and determine one placement among all the generated placement candidates according to a predefined criterion. As illustrated in FIG. 7, the placer 110 in the present embodiment may flip directions of some transistors constituting a NAND gate, and adjust the placement so that the NMOS transistors may share a diffusion region with each other.

Here, the diffusion region is a portion arranged between a source electrode and a drain electrode of a transistor. When the diffusion region is shared between a plurality of transistors, a cell width may be reduced. Accordingly, the placer 21 in the present disclosure may determine transistor placement according to a cost function including a cell area element according to the diffusion region. That is, by flipping a ZAN transistor and combining a NAZ transistor with the ZAN transistor, transistors may be placed (NAZAN) to minimize an area cost by taking into account sharing of diffusion regions between respective transistors. By doing so, as illustrated in FIG. 8, a placement (a) determined by the placer 21 in the present embodiment may lead to a routing (b) in which a wirelength resource in the router 22 may be reduced.

Meanwhile, the placer 21 in the present embodiment may perform placement according to steps through a logical unit clustering process to efficiently place transistors.

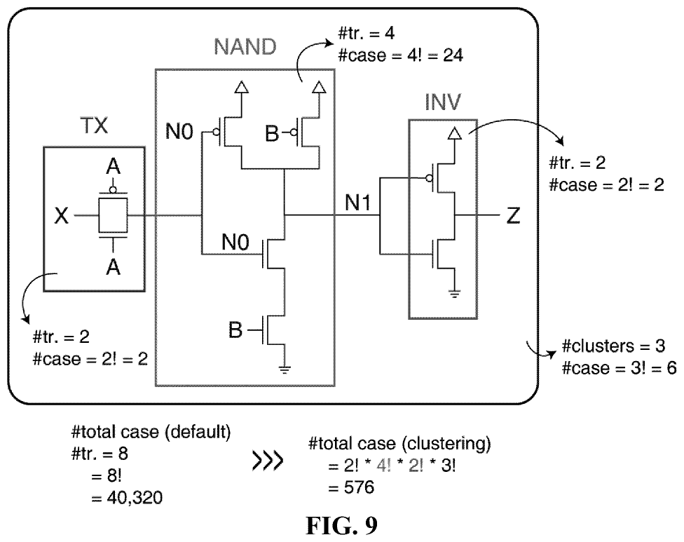

For example, as illustrated in FIG. 9, the placer 21 in the present embodiment may analyze logical connectivity between transistors to group transistors that are strongly connected to each other into one cluster. That is, although numerous transistors are needed to implement one logical function, a number of cases of placement of all transistors may be increased significantly according to an increase in a number of the transistors. Thus, the placer 21 in the present embodiment may first perform a clustering process to effectively determine placement of transistors, then, place the transistors in clusters, and then, determine placement between the clusters, thereby enabling more effective placement of the transistors.

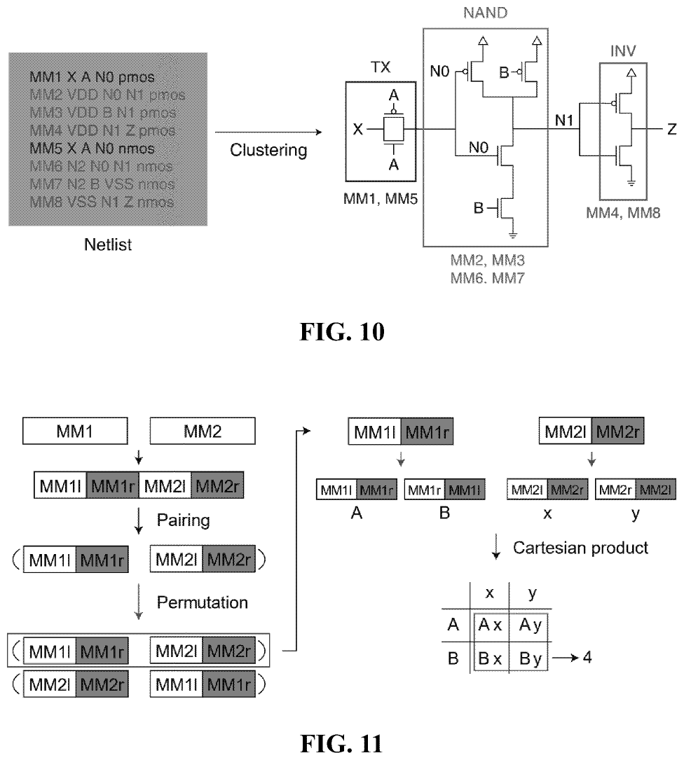

To do so, as illustrated in FIG. 10, the placer 21 in the present embodiment checks information (a source-drain connection relationship, VDD, VSS, etc.) regarding a plurality of transistors MMI1, MMI2, MMI3, MMI4, MMI5, MMI6, MMI7, and MMI8 for a particular logic function based on the netlist, and then, checks transistor source-drain connection information using the checked information and clusters transistors connected to a same signal network (net) to generate at least one cluster.

Then, as illustrated in FIG. 11, the placer 21 in the present embodiment may perform sub-placement for determining placement of respective transistors in one cluster.

As a process of performing the sub-placement, the placer 21 according to the present embodiment may check the transistors MM1 and MM2 clustered within one cluster, and through this, define an ordered pair (MM11MM1r, MM21MM2r) in which the respective transistors are separated into a source and a drain, i.e., 1 and r. Then, the placer 21 in the present embodiment generates possible placement candidates based on the defined ordered pair (MM11MM1r, MM21MM2r). For example, placement candidates ((MM11MM1r, MM21MM2r), (MM21MM2r, MM11MM1r)) may be generated through a permutation process for arrangement in a form in a particular order, e.g., by changing an internal order of transistors, changing between transistors, etc. Meanwhile, the permutation process may be performed on all ordered pairs. For example, all possible placement candidates may be generated, for example, through a Cartesian product operation.

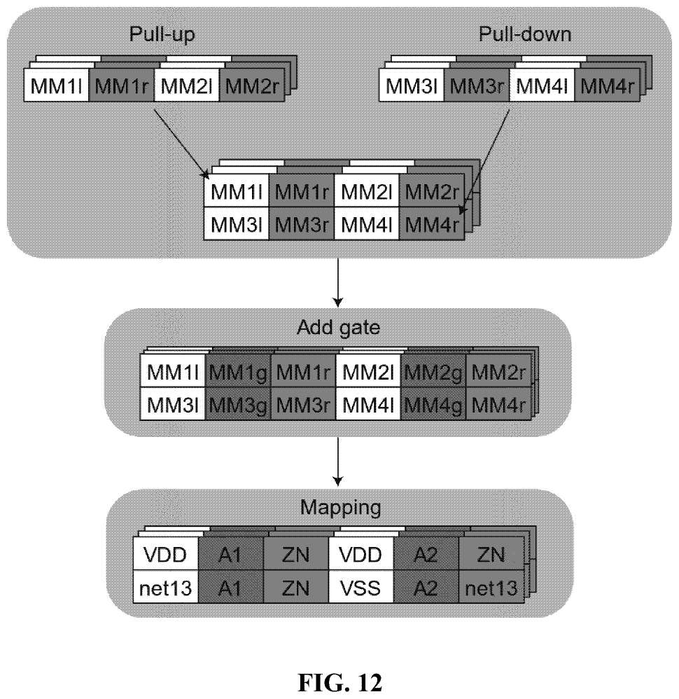

A process of sub-placement by the placer 21 is described further with reference to FIG. 12.

Transistors in a cluster are divided into transistors corresponding to a PMOS region and transistors corresponding to an NMOS region. Accordingly, the placer 21 in the present embodiment may merge transistor placement candidates classified into the PMOS region (pull-up) and the NMOS region (pull-down), add gates to the transistor placement candidates in a state of the merging, and map transistors defined in a netlist to the placement candidates to which the gates have been added.

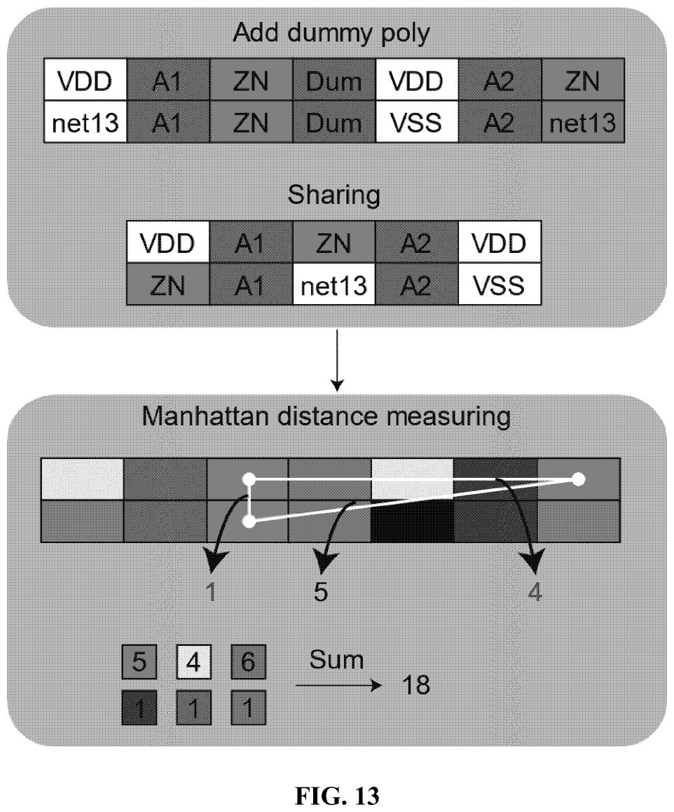

The process of sub-placement by the placer 21 is described further with reference to FIG. 13.

The placer 21 in the present embodiment determines whether diffusion region sharing may be performed. When the diffusion region sharing may be performed, a diffusion region is shared, and when the diffusion region sharing may be not performed, a dummy poly may be inserted (added) between poly gates to separate regions. Here, the dummy poly is used to maintain uniform process characteristics. By inserting the dummy poly, even in a situation in which diffusion regions may not be shared, transistors that satisfy design rules may be placed while preventing electrical interference.

Then, the placer 21 in the present embodiment may measure a distance between respective transistors for each of placement candidates generated through the above-described process, and select a placement candidate with a minimum cell area based on the measured distance to thereby complete a setting for final transistor placement with respect to a corresponding cluster. At this time, the placer 21 in the present embodiment may measure a distance between respective transistors according to a preset distance measurement technique, such as a Manhattan distance. Meanwhile, in the present embodiment, placement of transistors is determined based on a distance between the transistors, but this is only an example. It is obvious that placement of transistors may be determined by applying other measurement methods to the transistors.

The sub-placement process may be performed on each of all clusters. When the sub-placement described above is completed for each of all the clusters, the placer 21 in the present embodiment may perform top-placement, which is placement between clusters.

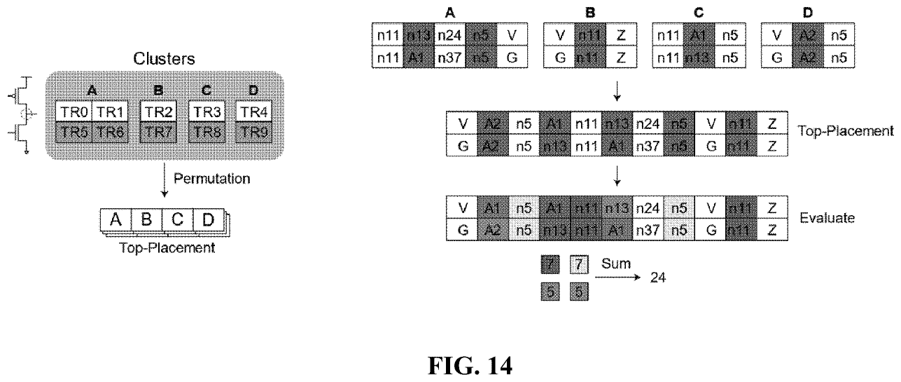

In relation to this, referring to FIG. 14, when it is assumed that clusters A, B, C, and D are present, permutation may be performed on the clusters to generate placement candidates for the clusters A, B, C, and D. At this time, like the sub-placement, the placer 21 in the present embodiment may determine whether diffusion region sharing may be performed, and when diffusion region sharing may not be performed, a dummy poly may be inserted, thereby optimizing connection of transistors during placement between clusters. Then, when placement is performed through a combination between the clusters, the placer 21 in the present embodiment may set, as a final cluster placement, a combination in which a wirelength (a distance) between respective clusters is minimized. Thus, the placement of a plurality of clusters may be completed.

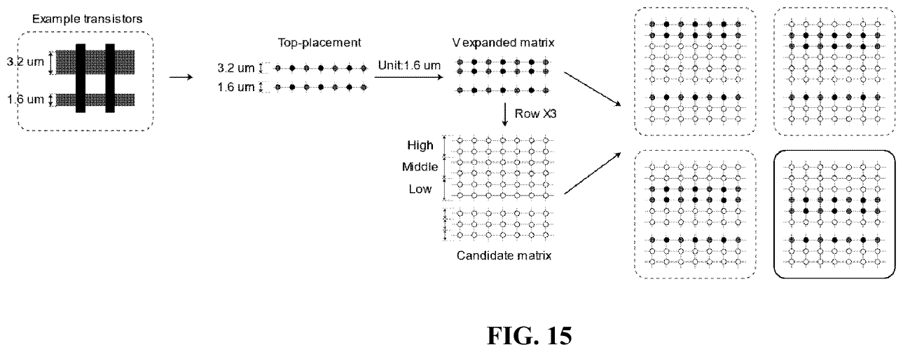

Meanwhile, as described above, the placement is determined according to a process of the top-placement. However, in this case, the placement of transistors indicates an order of the transistors, and needs to be performed by taking into account actual widths of the transistors. To do so, the placer 21 in the present embodiment performs vertical-placement (V-placement) as illustrated in FIG. 15.

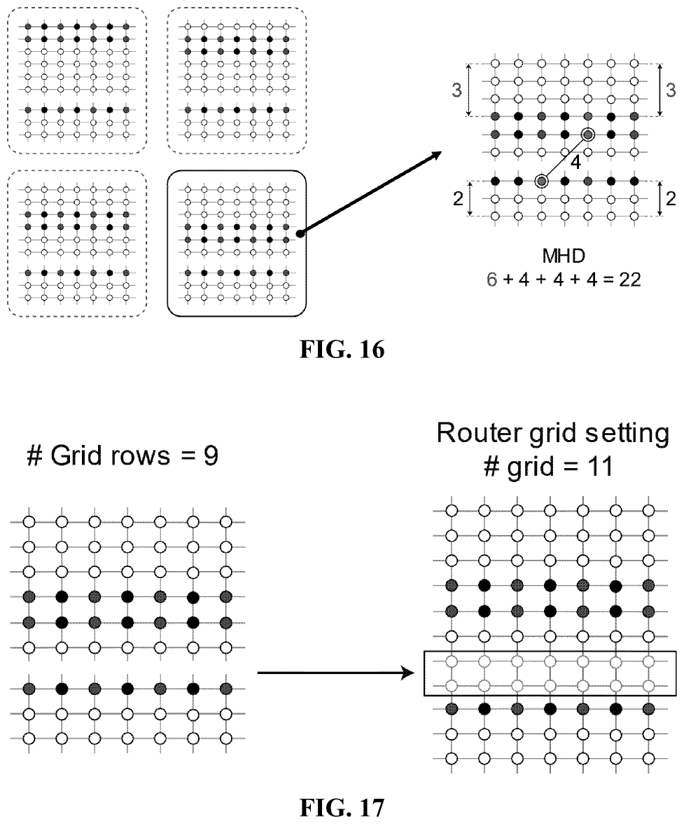

Referring to FIG. 15, when it is assumed that transistors 1 and 2 are present, the placer 21 in the present embodiment may check a transistor size and design constraints checked through a PDK. At this time, when a height of the transistor 1 is 3.2 μm and a height of transistor 2 is 1.6 μm, vertical placement of the transistors need to be performed, i.e., based on a height. Therefore, a cell layout that satisfies a height of 3.2 μm adjustable in a unit of 1.6 μm needs to be generated. To do so, the placer 21 in the present embodiment may generate a grid by expanding a row to a predetermined range according to a transistor width. Based on the grid generated as a result of the expanding, the placer 21 in the present embodiment may match various placement candidates. Then, as illustrated in FIG. 16, the placer 21 in the present embodiment may determine one placement candidate with a minimum distance (a wirelength) among the respective placement candidates that match the grid, and place transistors for the determined placement candidate to complete a final placement process.

As described above, the placer 21 performs clustering-based placement according to steps when placing transistors, and automatically determines a placement based on a preset criterion for each step, thereby enabling efficient transistor placement.

In addition, as the placer 21 in the present disclosure performs the V-placement to place transistors on a grid, the router 22 according to an embodiment of the present disclosure may easily insert an additional grid as needed when a routing is determined, as shown in FIG. 17. At this time, the grid may be inserted based on a unit length for routing optimization.

The first embodiment of the placement process by the placer according to an embodiment of the present disclosure has been described.

As described above, the first embodiment of the placement process by the placer according to an embodiment of the present disclosure has been described mainly about a case when the placer 21 performs a placement in consideration of a predefined criterion for device characteristics (a wirelength, a cell area, etc.).

Hereinafter, the second embodiment of a placement process by a placer according to an embodiment of the present disclosure is to be described.

The second embodiment of the placement process by the placer according to an embodiment of the present disclosure may be a process of performing a placement according to a process and device-friendly design condition in which semiconductor manufacturing process characteristics and device characteristics are taken into account.

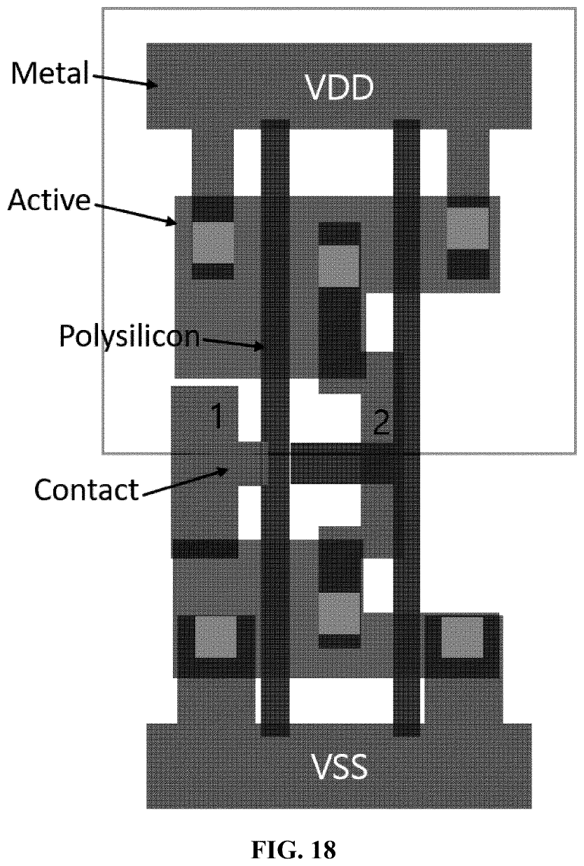

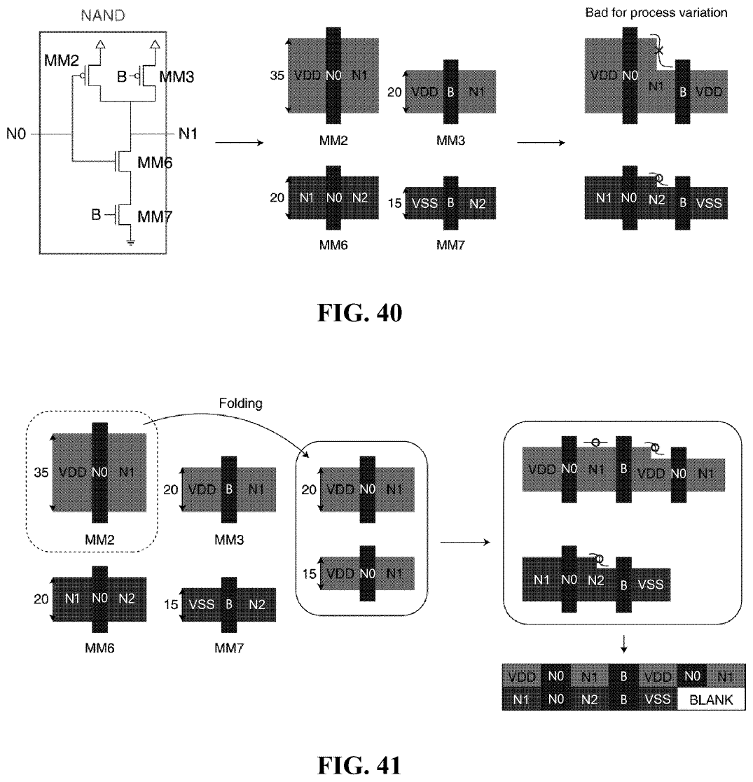

FIGS. 18 to 25 are diagrams illustrating examples for explaining a second embodiment of the placing process by the placer according to an embodiment of the present disclosure. FIGS. 40 and 41 are diagrams illustrating an example for explaining an active folding process in the placer according to an embodiment of the present disclosure.

First, in FIG. 18, portions expressed in red are silicon regions in which transistors operate, i.e., active areas. The placer 21 according to an embodiment of the present disclosure determines a placement in consideration of a predefined criterion, e.g., widths of transistors. Areas of the transistors at this time may be checked from, e.g., a PDK, or may be determined by the placer 21 based on performance requirements, etc.

According to an embodiment of the present disclosure, widths of transistors are equal to or greater than a predetermined length, the placer 21 may place the transistors by folding active areas of the transistors to basically reduce a physical size.

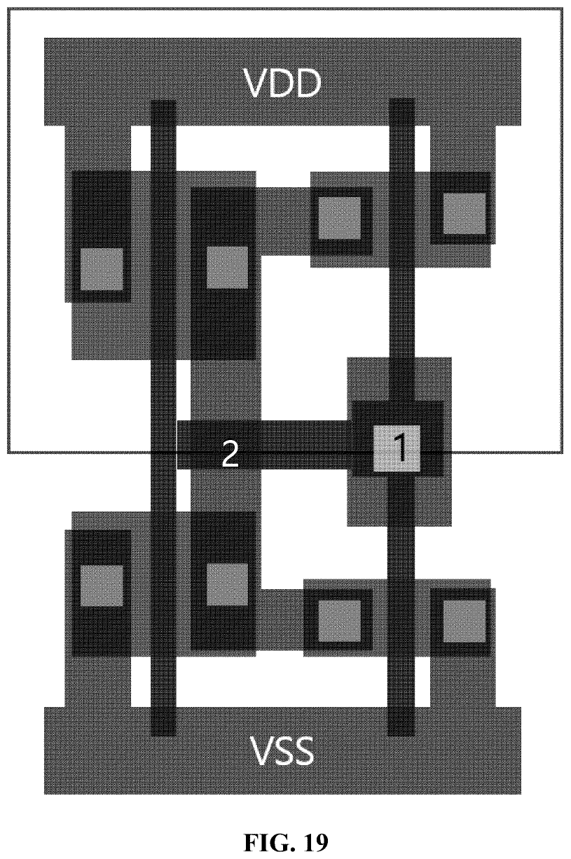

In addition, the placer 21 according to an embodiment of the present disclosure may check widths of transistors and, when transistors having different areas are adjacent, the transistors may be placed by separating active areas as illustrated in FIG. 19.

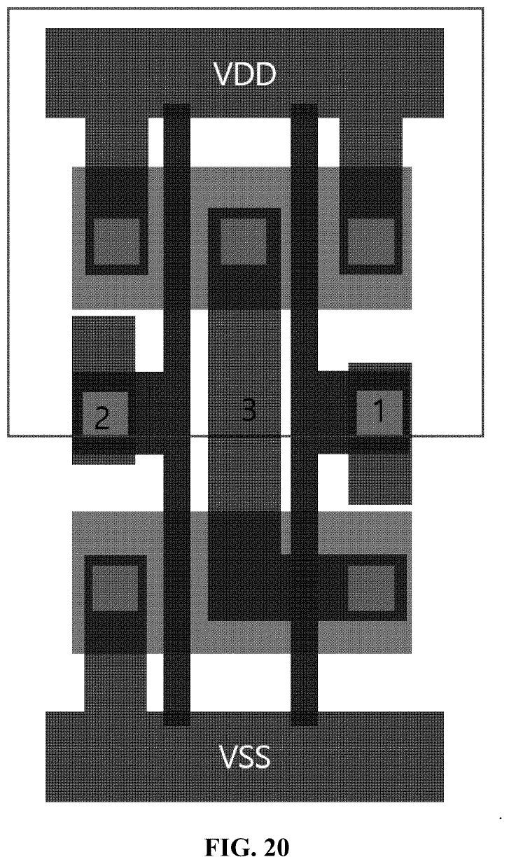

In addition, the placer 21 according to an embodiment of the present disclosure may check widths of transistors and, when transistors have a same area, the transistors may be placed to share active areas through a diffusion region as illustrated in FIG. 20.

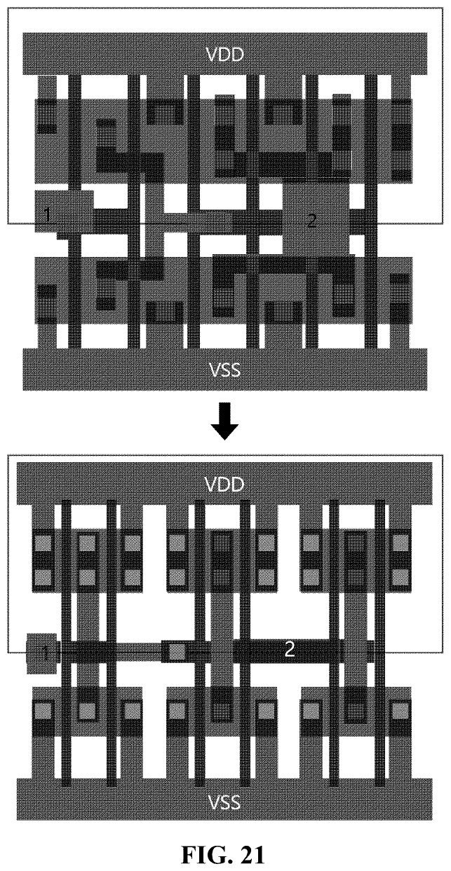

At this time, even though transistors having a same area, in a case in which a number of fingers is equal to or greater than a certain number, for example, three or more, process variations increase due to LFD characteristics when a diffusion region is shared, thereby increasing device characteristic variability. Therefore, when transistors having a same area are present, the placer 21 according to an embodiment of the present disclosure may further check a number of fingers, and separate active areas as shown in FIG. 21. Thus, device characteristic variability characteristics may be improved and an effect of satisfying a preset yield condition may be achieved.

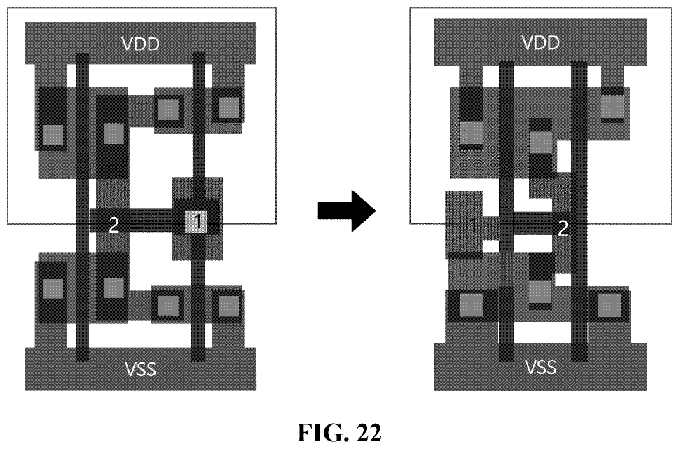

Meanwhile, as described with reference to FIG. 19, the placer 21 according to an embodiment of the present disclosure checks areas of transistors and, when transistors having different areas are adjacent, place the transistors basically by separating active areas. At this time, the placer 21 according to an embodiment of the present disclosure may check a design rule through process characteristics, and like a case when a minimum area is taken into account with a priority in the design rule, may place the transistors by sharing the active area to satisfy the design rule (FIG. 22).

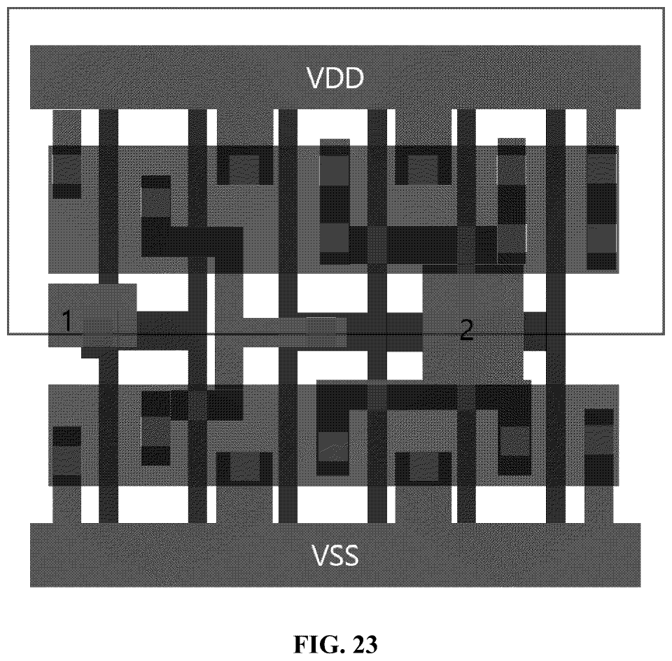

In addition, as illustrated in FIG. 23, the placer 21 according to an embodiment of the present disclosure may check widths of transistors and, when transistors with different widths are adjacent, may adjust a transistor having a great width in correspondence with a transistor having a small width, i.e., adjust two different transistors to have a same width using multiple fingers to place the transistors to share a single active area.

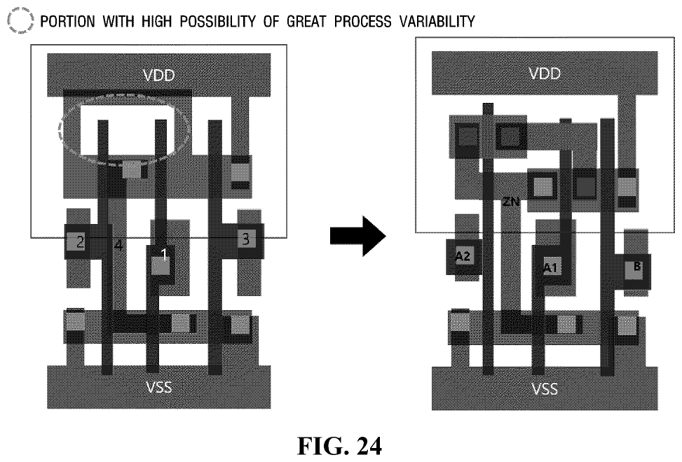

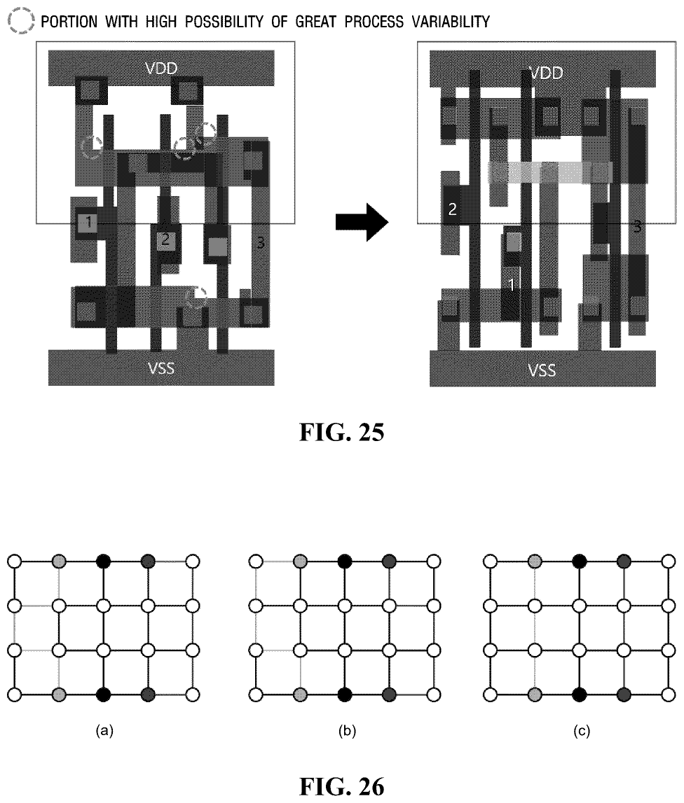

In addition, as illustrated in FIGS. 24 and 25, to resolve changes in device characteristics which may be caused by process variability, the placer 21 according to an embodiment of the present disclosure may change a cell layout in a portion in which there is a high possibility of great process variability. In detail, as shown in portions marked in a left drawing of FIG. 25, when a corner and a poly are close to each other in an active area, widths of transistors may be changed depending on process variability. Thus, a cell layout may be changed as shown in a right drawing of FIG. 25.

Meanwhile, as illustrated in FIG. 40, when a diffusion region is shared in a cluster, a width difference between transistors may have a negative impact on a yield. Accordingly, the placer 21 according to an embodiment of the present disclosure may perform additional transistor folding processing, as illustrated in FIG. 41, on a corresponding transistor having a width difference caused in a sub-placement process. In detail, the placer 21 according to an embodiment of the present disclosure may perform folding on respective transistors to divide widths of the respective transistors, and then, place the transistors to share active areas through transistors obtained by the dividing. At this time, after performing the folding on the transistors, the placer 21 according to an embodiment of the present disclosure may find a combination of transistors with a smallest width difference within a cluster, and place the transistors to share active areas between the transistors in the combination.

Through the process described above, the placer 21 according to an embodiment of the present disclosure may place transistors in consideration of a process and device-friendly design condition in which semiconductor manufacturing process characteristics and device characteristics are taken into account. Thus, process variability may be reduced while improving yield, and placement may be performed by effectively controlling an area.

Hereinafter, a routing process by a router according to an embodiment of the present disclosure is to be described separately for a first embodiment and a second embodiment.

FIGS. 26 to 30 are diagrams illustrating examples for explaining a first embodiment of a routing process by the router according to an embodiment of the present disclosure.

First, referring to FIG. 26, the router 22 in the present embodiment may perform an efficient routing determination process in correspondence with each placement determined by the placer 21. To do so, the router 22 in the present embodiment may be set as a router that satisfies a grid and a satisfiability modulo theory (SMT), and in detail, derive a solution that satisfies all design objectives derived from a PDK on the grid according to the SMT (as shown in (a) and (b)), and automatically determine a routing as shown in (c) according to the derived solution.

At this time, the router 22 in the present embodiment may take into account characteristics of respective individual routings (net) to thereby set design objectives for the respective routings, rather than setting a same design objective for the respective routings. For example, since a clock signal routing, a data signal routing, and power supply and ground wires have different characteristics, different design objectives may be set in consideration of characteristics of the respective routings. That is, as illustrated in FIG. 27, the router 22 in the present embodiment may set different design objectives (constraints according to routing characteristics) depending on routing characteristics such as a blue constraint (a), a red constraint (b), and a green constraint (c).

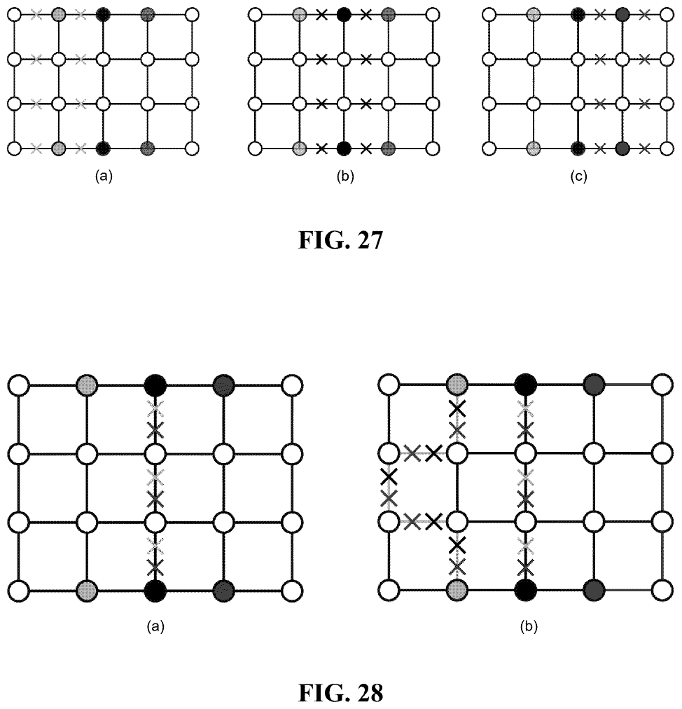

In addition, as illustrated in FIG. 28, the router 22 in the present embodiment may further set a constraint by taking into account correlations between respective routings such that when one routing uses a particular path (an edge), other routings do not use the particular path. By doing so, routing conflicts and interference between signals may be prevented.

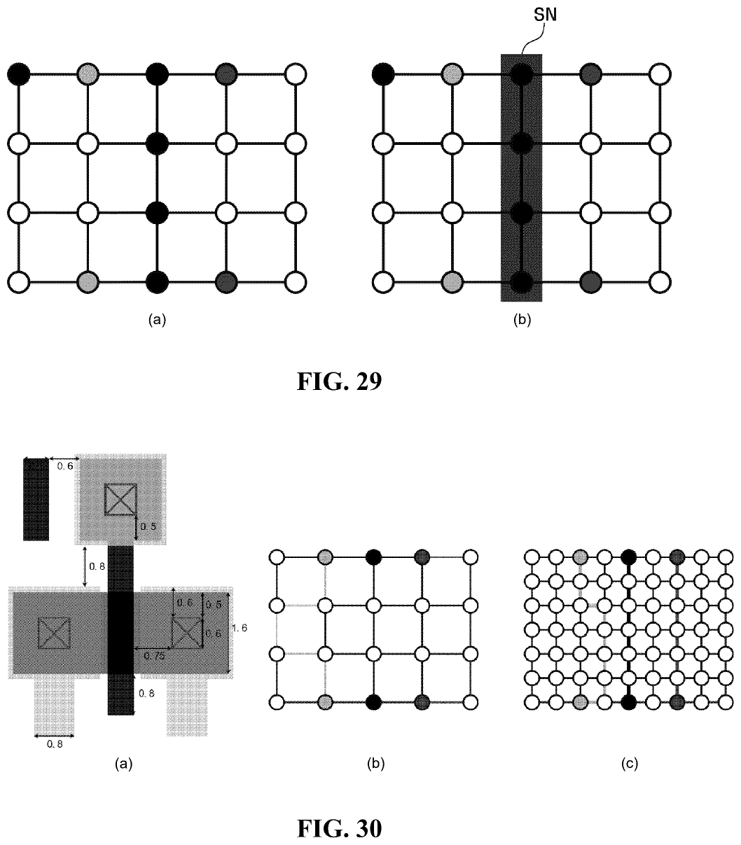

In addition, as illustrated in FIG. 29, like a gate poly node, since a PMOS region and an NMOS region may be connected as one continuous poly node when located in a same column, the router 22 in the present embodiment may set a routing for one super node (SN) without having to separately place an individual poly node, and then, set a routing for transistors. By doing so, a cell layout with a minimized routing path may be generated.

In addition, as illustrated in FIG. 30, a phenomenon in which an additionally inserted grid shown in (b) does not match a design rule shown in (a) according to a design objective checked through the PDK may occur in the router 22. For example, as illustrated in (b), when it is identified that a basic grid unit of a determined routing is 0.1 μm but a routing space in transistors checked through the design objective is 0.07 μm, the grid unit does not match the routing space. Thus, the router 22 in the present embodiment may change the grid unit to be smaller in a multiple of units (Nx), that is, to a finer grid in a form illustrated in (c). By doing so, a finer routing may be set.

Meanwhile, the router 22 in the present embodiment may further perform routing optimization in consideration of layers, by taking into account a case of being applied to a FinFET process. For example, the router 22 in the present embodiment may expand a number of vertical tracks in consideration of a gear ratio, i.e., a ratio between a poly pitch and a metal-1 pitch (M1 pitch), and optimize a routing in a form in which a contact or a via is placed only in a portion where tracks of respective layers overlap each other.

Hereinafter, the second embodiment of a routing process by a router according to an embodiment of the present disclosure is to be described. The second embodiment of the routing process by the placer according to an embodiment of the present disclosure may be a process of performing a placement based on a process and device-friendly design condition in which semiconductor manufacturing process characteristics and device characteristics are taken into account.

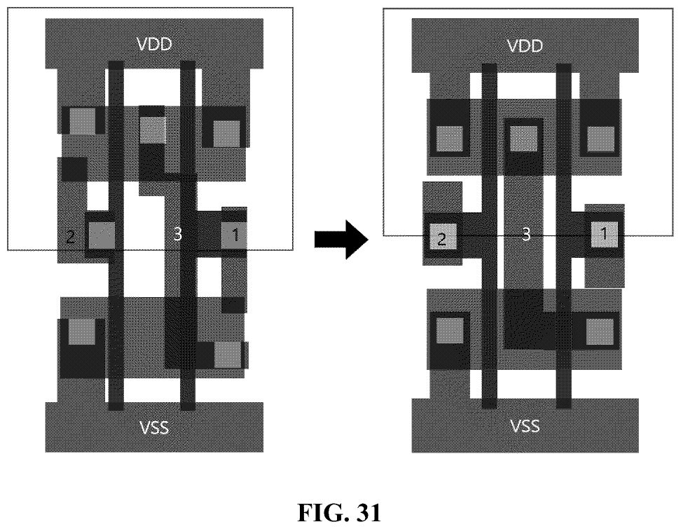

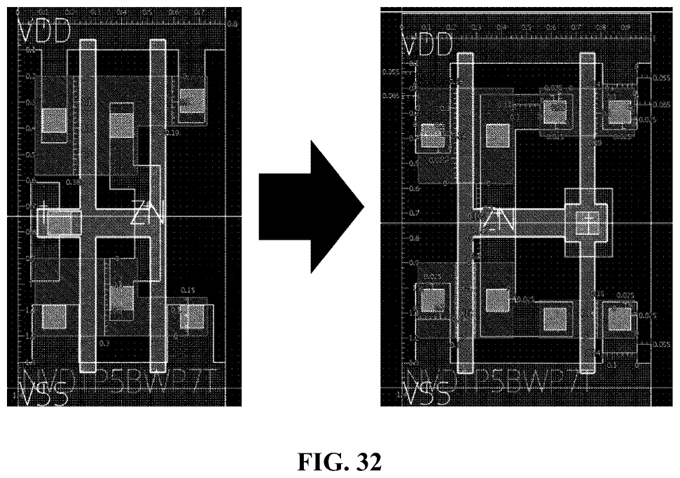

FIGS. 31 and 32 are diagrams illustrating an example for explaining a second embodiment of the routing process by the router according to an embodiment of the present disclosure.

First, as illustrated in FIG. 31, the router 22 according to an embodiment of the present disclosure determines a routing by connecting a transistor of which placement has been determined to a metal layer according to a predefined criterion. For example, a routing may be performed with one or more metal layers or contact layers, or one or more via layers, when necessary, through alignment in one direction. The one direction at this time may be a vertical direction or a horizontal direction. By doing so, process variability may be reduced and a manufacturing yield may be increased.

In addition, as illustrated in FIG. 32, to reduce variations in device characteristics, the router 22 according to an embodiment of the present disclosure may symmetrically place contact positions (green areas) of the contact layers with reference to a poly gate arranged at a center in consideration of a transistor diffusion active area. A number of contacts at this time may be determined as great as possible within the transistor diffusion active area, but may be adjusted in consideration of complexity of a routing.

In addition, the router 22 according to an embodiment of the present disclosure may apply a metal overlap to prepare against mask alignment errors due to a lithography process. That is, a routing is performed more widely in a metal area than in a contact area of the contact layer.

In addition, the router 22 according to an embodiment of the present disclosure determines a routing in consideration of a design rule designated for a PDK during the routing process described above.

As such, the router 22 according to an embodiment of the present disclosure determines an efficient routing in consideration of a process and device-friendly design condition in which semiconductor manufacturing process characteristics and device characteristics are taken into account.

The operations of the placer 21 and the router 22 according to an embodiment of the present disclosure have been described separately for the first embodiment and the second embodiment.

However, the operations of the placer 21 and the router 22 according to an embodiment of the present disclosure are not limited to the first embodiment and the second embodiment. When an operation is performed according to a predefined criterion, especially when an operation is performed in consideration of a process and device-friendly design condition in which semiconductor manufacturing process characteristics and device characteristics are taken into account, any embodiment may be applied to the present disclosure.

Meanwhile, the placer 21 and router 22 according to another embodiment of the present disclosure may determine a placement and a routing by further taking pin accessibility into account.

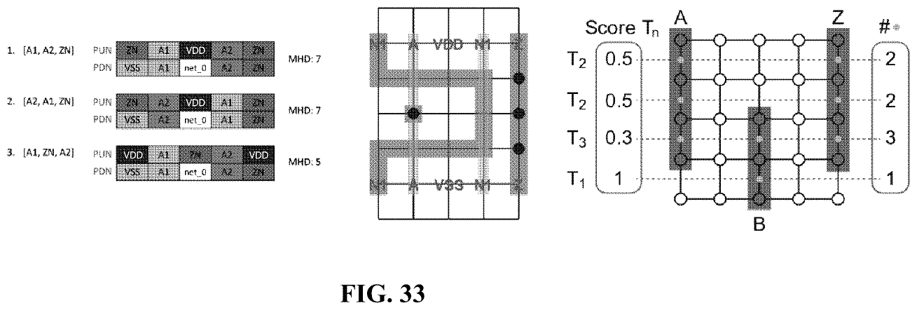

Hereinafter, operations of the placer 21 and the router 22 in which pin accessibility is taken into account according to another embodiment of the present disclosure are described with reference to FIGS. 33 to 35.

FIGS. 33 to 35 are diagrams illustrating an example for explaining operations of a placer and a router according to another embodiment of the present disclosure.

The placer 21 and the router 22 according to another embodiment of the present disclosure may expand a plurality of cell layouts by further taking into account pin accessibility, with respect to a cell layout generated through the above-described process. In other words, the placer 21 and the router 22 according to another embodiment of the present disclosure may increase flexibility of routing optimization by generating a plurality of cell layouts having several different pin locations in correspondence with an input netlist. At this time, the routing optimization may mean improvement of pin accessibility within a cell, or have a concept of increasing overall routing flexibility during chip implementation, or refer to improvement of RC parameters.

First, as illustrated in (a) of FIG. 33, the placer 21 in the present embodiment may generate a plurality of placements 1, 2, and 3 including different pin positions in one axis (e.g., x-axis) direction.

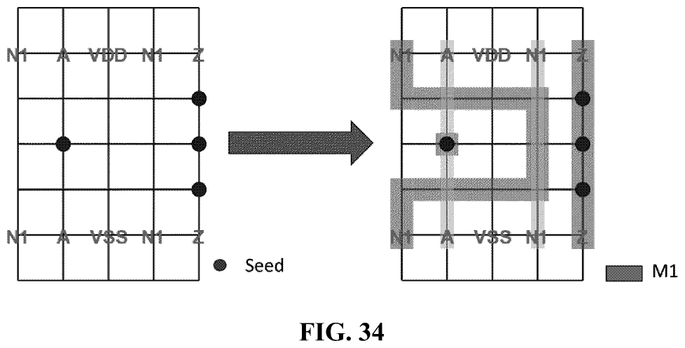

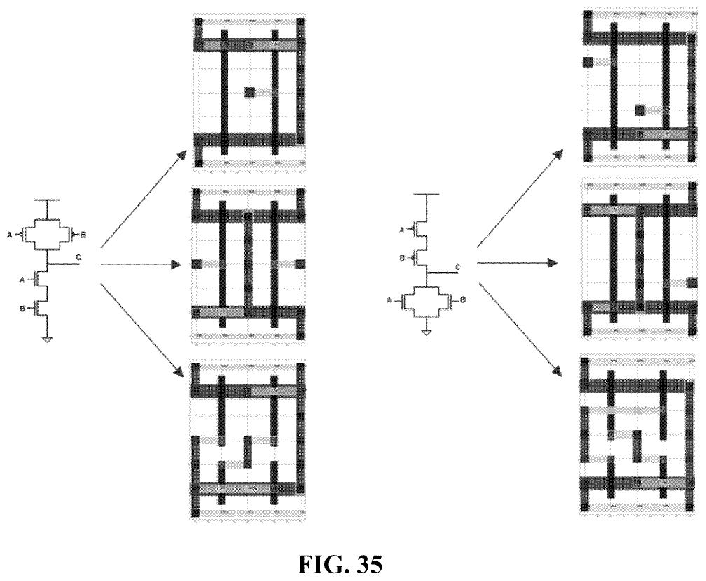

The router 22 in the present embodiment may determine a routing using a method of correcting the pin positions in the plurality of placements 1, 2, and 3 determined by the placer 21 and scoring pin accessibility. In detail, as illustrated in (b) of FIG. 33, the router 22 in the present embodiment may select seed pins. Referring to FIG. 34 which is a detailed drawing of (b) of FIG. 33, the router 22 selects seed pins in a placement including different pin positions as shown in (a), and extends a routing path with reference to the selected seed pins as shown in (b). In addition, as shown in (c) of FIG. 33, the router 22 in the present embodiment calculates a pin score for pin accessibility based on a number of pin intersections with a track which is a routing path from the seed pin, and determines a routing in which the calculated pin score is maximized, to finally generate a plurality of additional cell layouts as illustrated in FIG. 35. By doing so, a cell layout library that varies depending on pin accessibility may be generated.

In addition, when pin accessibility is taken into account, the placer 21 and the router 22 according to another embodiment of the present disclosure may perform placement and routing by further considering a process and device-friendly design condition in which semiconductor manufacturing process characteristics and device characteristics are taken into account.

In detail, when pins are placed at different positions, the placer 21 in the present embodiment may determine placement of the pins in consideration of a routing with a metal layer by the router 22 in the present embodiment.

In addition, the router 22 in the present embodiment may check all possible combinations based on the determined pin placement, and determine one pin combination from all the possible combinations, in consideration of a predefined criterion, i.e., a process and device-friendly design condition in which semiconductor manufacturing process characteristics and device characteristics are taken into account, e.g., a minimum cell size, a minimum wirelength, pin accessibility, power, performance, and area (PPA), and a metal layer, and determine a routing according to the determined pin combination.

The cell layout generation device 200 including the cell layout generator 20 according to an embodiment of the present disclosure has been described above.

A configuration in which the cell layout generator 20 that may include the placer 21 and the router 22 as described above may place transistors and determine a routing according to a predefined criterion to generate a cell layout in the cell layout generation device 200 according to an embodiment of the present disclosure has been described. However, the cell layout generation device 200 according to another embodiment of the present disclosure may perform a process of continuously optimizing a cell layout generated by interoperating with an optimization engine to generate an optimized cell layout.

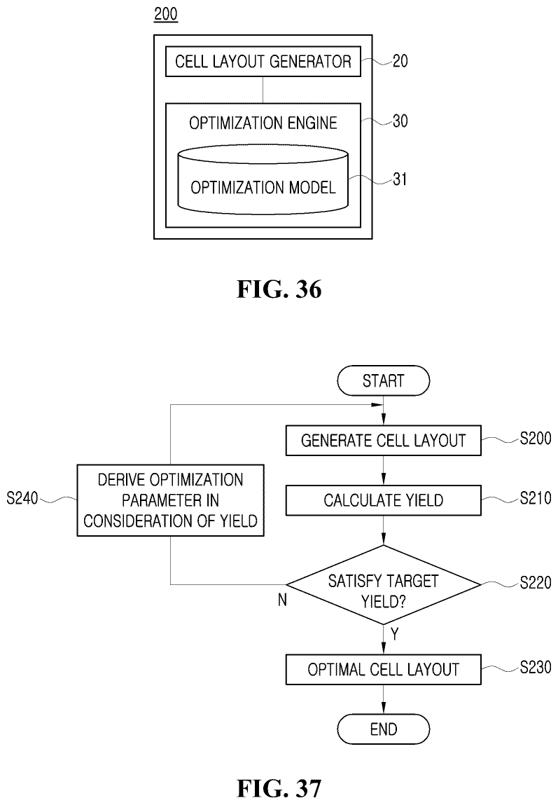

A cell layout generation device according to another embodiment of the present disclosure is to be described with reference to FIGS. 36 to 38.

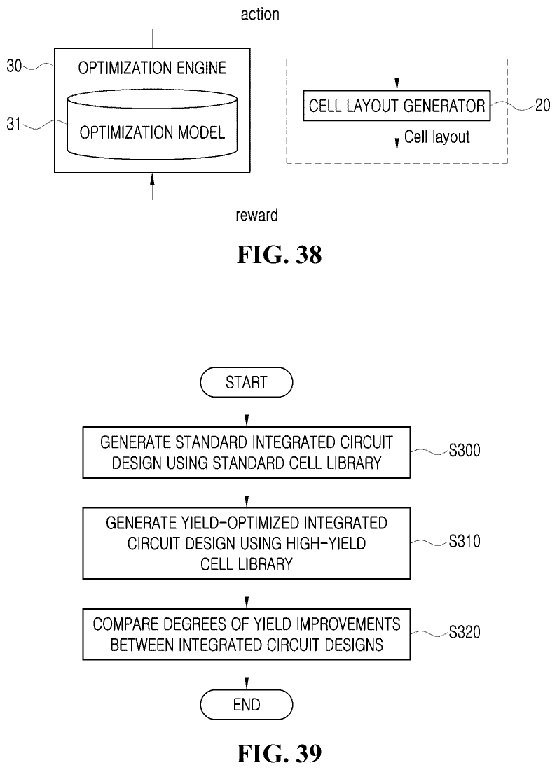

FIG. 36 is a block diagram illustrating main components a cell layout generation device according to another embodiment of the present disclosure. FIG. 37 is a flowchart for explaining an operation of the cell layout generation device according to another embodiment of the present disclosure. FIG. 38 is a diagram illustrating for explaining operation of the cell layout generation device according to another embodiment of the present disclosure.

First, referring to FIG. 36, the cell layout generation device 200 according to another embodiment of the present disclosure may be configured to include the cell layout generator 20 and an optimization engine 30 including a yield optimization model 31 provided in advance.

First, the cell layout generator 20 according to another embodiment of the present disclosure may perform a function of determining a placement corresponding to at least one transistor according to a predefined criterion based on data input to generate a cell layout, and determining a routing corresponding to the determined placement to generate the cell layout. At this time, the cell layout generator 20 in another embodiment of the present disclosure may have same configurations and functions as those the cell layout generator 20 illustrated in FIG. 3. Thus, a detailed description thereof will be not be provided here again.

The optimization engine 30 according to another embodiment of the present disclosure performs a function of deriving an optimization parameter for a yield of the cell layout generated by the cell layout generator 20 using the yield optimization model 31 and transmitting the derived optimization parameter for the yield to the cell layout generator 20.

The cell layout generator 20 and the optimization engine 30 in the present embodiment may desirably repeat an optimization process until the generated cell layout satisfies a preset target yield.

In relation to this, referring to FIG. 37, the cell layout generator 20 in the present embodiment generates a cell layout based on input data according to a predefined criterion (S200). At this time, the predefined criterion may be a process and device-friendly design condition in which semiconductor manufacturing process characteristics and device characteristics are taken into account.

Thereafter, the cell layout generator 20 in the present embodiment calculates a yield for the generated cell layout (S210). The yield in the present embodiment is calculated on an assumption that defects are uniformly distributed, and may be calculated using Equation 1 below.

$$Y = {( 1 + \frac{AD}{N} )}^{- N} \qquad Equation 1$$

Here, D represents an existing defect density, and A represents an area. N represents a defect clustering factor, and may be, for example, a Murphy coefficient which refers to a constant parameter applied to calculate a yield. That is, when a defect density is great or the area is great, a yield Y may be decreased.

Meanwhile, the cell layout generator 20 in the present embodiment may calculate a yield as presented in Equation 2 below by further considering a process variability variable V.

$$Y = {( 1 + \frac{A ( D \cdot V )}{N} )}^{- N} \qquad Equation 2$$

The cell layout generator 20 in the present embodiment calculates a yield according to Equations presented above, and then, determines whether the calculated yield satisfies a preset target yield (S220), and when the preset target yield is satisfied, outputs the cell layout (S230). When the preset target yield is not satisfied, the optimization engine 30 in the present disclosure derives an optimization parameter for a yield, the optimization parameter capable of reducing a value of D in Equation 1 above to improve the yield (S240).

Then, the cell layout generator 20 in the present embodiment may change the generated cell layout according to the optimization parameter derived by the optimization engine 30 to generate a cell layout again (S200), and likewise, calculate a yield again (S210) and evaluates the calculate the yield (S220), to thereby generate an optimal cell layout that satisfies the target yield (S230).

In addition, as illustrated in FIG. 38, the yield optimization model 31 configured to derive an optimization parameter in the present embodiment may be a model configured to adjust and derive a particular parameter value, i.e., for an action to maximize a reward based on reinforcement learning. For example, the yield optimization model 31 in the present embodiment defines a current state (a layout configuration, a performance index, design rule violation information, etc.), defines possible actions (placement, routing, etc.), and derives optimization parameters for the actions to maximize a reward in a state when a reward function in which a yield objective is reflected is predefined.

The optimization parameters derived according to performance of the actions are transmitted to the cell layout generator 20. Then, the cell layout generator 20 may perform an optimization process using a feedback method by performing an action of changing a cell layout, evaluating whether a cell layout obtained as a result of the changing has an optimized yield compared to the cell layout before the changing by using a reward function, and adjusting a parameter value again according to the reward function.

An example of deriving an optimization parameter according to the present embodiment through a parameter optimization model based on reinforcement learning has been described above. However, the present disclosure is not limited thereto, and any optimization technique capable of optimizing a parameter according to feedback other than the reinforcement learning may be applied to the optimization model 31 according to the present embodiment. For example, a method such as optimization using learning like optimization through neural networks, Bayesian optimization, etc., or gradient-based optimization using a differentiable objective function may be used.

Meanwhile, in a semiconductor process, characteristics of respective devices may be present due to limitations in fine process technology or process deviation. Ignorance of such characteristics may lead to performance degradation or reliability issues. Thus, variations should be taken into account during a cell layout design stage. To take into account such process/device variations, a margin needs to be provided in a design or additional cell layout adjustments, i.e., a cell layout optimization process is needed. A cell layout derived through such an optimization process may result in an overhead problem such that an area is increased.

Thus, the optimization engine 30 according to the present embodiment may derive parameters according to multiple optimization objectives (multi-objectives) such that at least one different objective is simultaneously optimized together with a yield. For example, the optimization engine 30 according to the present embodiment may take into account at least one of predefined design optimization objectives, such as area optimization, wirelength optimization, power optimization, pin accessibility, and power-ground rail optimization, together with yield optimization.

In particular, the optimization engine 30 according to the present embodiment may derive an optimization parameter by comprehensively considering an impact on each element of performance (P), power consumption (P), and area (A) (hereinafter referred to as PPA), while taking into account both the design objectives as described above and optimization objectives predefined for yield optimization. In detail, an optimization parameter for minimizing an area may have low tolerance for process/device variability, and conversely, an optimization parameter in which the process/device variability is thoroughly reflected may cause a slight increase in an area. Therefore, the optimization engine 30 according to the present embodiment may ultimately derive an optimization parameter to optimize PPA of a whole system while taking into account all optimization objectives having a trade-off relationship.

To do so, the optimization engine 30 according to the present embodiment may find optimization points that satisfy the multiple optimization objectives, and derive optimization parameters by reflecting importance weights for respective optimization objectives according to the optimization points. That is, importance weights in the multi-objectives are explored from optimization points which are not inferior to all objectives. The optimization points may be explored using Pareto frontier which is a boundary curve of a set of non-dominated solutions.

In detail, the optimization engine 30 according to the present embodiment may set an objective function in which the multiple optimization objectives described above are reflected, add constraints, and derive an optimization parameter from an optimization point most suitable for requirements for PPA among optimization points that satisfy all of the multiple optimization objectives.

By doing so, the optimization engine 30 in the present embodiment derives an optimization parameter adjustable to approach the multiple optimization objectives, and the cell layout generator 20 performs an optimization process of changing a cell layout according to the optimization parameter.

The above-described optimization process is terminated when the optimization objective is reached, thereby generating optimal cell layouts. Ultimately, the cell layout generation device 200 according to the present embodiment may generate the high-yield cell library 100 which is a set of the optimal cell layouts.

Then, the integrated circuit design system to which the high-yield cell library 100 generated by the cell layout generation device 200 according to the present embodiment is applied may immediately verify a yield improvement at an engineering change order (ECO) stage.

This is to be explained with reference to FIG. 39.

FIG. 39 is a flowchart for explaining an operation according to still another embodiment of the present disclosure.

Referring to FIG. 39, the integrated circuit design system according to the present embodiment generates an original integrated circuit design using a standard cell library (S300) and generates a yield-optimized integrated circuit design by applying the high-yield cell library 100 (S310) Then, an yield improvement by the high-yield cell library may be verified by comparing degrees of yield improvements between the original integrated circuit design and the yield-optimized integrated circuit design at an engineering change order (ECO) stage (S320).

As such, an integrated circuit design system to which a high-yield cell library according to the present embodiment is applied may change an original integrated circuit design generated based on a standard cell library to a high-yield cell at an ECO stage by applying a criterion for the design for manufacturability (DFM). Thus, a design objective of a designer may be easily achieved with minimal changes, and this process may be immediately output and guided to the designer.

A cell layout generation device for integrated circuit design according to an embodiment of the present disclosure, a system including the same, and a method using the same have been described above.

A method of generating a cell layout in the present disclosure as described above may be provided in a form of a computer-readable medium suitable for storing computer program instructions and data thereon.

Computer-readable media suitable for storing computer program instructions and data include, for example, magnetic media such as a hard disk, a floppy disk, and a magnetic tape, optical media such as a compact disk read only memory (CD-ROM) and a digital video disk (DVD), magneto-optical media such as a floptical disk, and semiconductor memories such as a read only memory (ROM), a random access memory (RAM), a flash memory, an erasable programmable ROM (EPROM), and an electrically erasable programmable ROM (EEPROM). A processor and a memory may be supplemented by or integrated into logic circuitry for a special purpose.

In addition, the computer-readable recording medium may also be distributed over network coupled computer systems so that the computer-readable code is stored and executed in a distributed fashion In addition, functional programs for implementing the present disclosure and codes and code segments related thereto may be easily construed or changed by programmers in the technical field to which the present disclosure belongs, by taking into consideration a system environment of a computer configured to execute a program by reading recording media.

In addition, a computer program recorded on a computer-readable recording medium as described above includes instructions that perform the functions described above, and is distributed and circulated through the recording medium, and is read by, and installed and executed on a particular device or a particular computer, thereby executing the functions described above.

Although the present disclosure has been described with reference to an embodiment illustrated in the drawings, this is only an example, and it will be understood by those of ordinary skill in the art that various changes in the form and details may be made therein without departing from the spirit and scope of the present disclosure as defined by the following claims.

### EXPLANATION OF REFERENCE NUMERALS

100: High yield cell library
200: Cell layout generation device

1. A cell layout generation device for integrated circuit design, the cell layout generation device comprising a cell layout generator configured to determine a placement corresponding to at least one transistor according to a predefined criterion based on data input to generate at least one cell layout, and generate the at least one cell layout by determining a routing corresponding to the placement,
wherein the predefined criterion is a process and device-friendly design condition in which semiconductor manufacturing process characteristics and device characteristics are taken into account.

2. The cell layout generation device of claim 1, wherein the cell layout generator comprises:
a placer configured to determine one or more placements applicable in correspondence with at least one transistor capable of performing a particular logic function based on the data input according to the predefined criterion; and
a router configured to generate the at least one cell layout by determining one or more routings applicable in correspondence with the one or more placements according to the predefined criterion.

3. The cell layout generation device of claim 2, wherein the placer determines the placement of the at least one transistor by folding, sharing or separating an active area of at least one transistor according to the predefined criterion, and
wherein the router determines the one or more routings by connecting the at least one transistor of which the placement is determined to one or more metal layers and contact layers according to the predefined criterion.

4. The cell layout generation device of claim 1, wherein the semiconductor manufacturing process characteristics and the device characteristics satisfy a lithography process condition.

5. A cell layout generation device for integrated circuit design, the cell layout generation device comprising:
a cell layout generator configured to determine a placement corresponding to at least one transistor according to a predefined criterion based on data input to generate a cell layout, and generate the cell layout by determining a routing corresponding to the placement; and
an optimization engine configured to derive an optimization parameter for a yield of the cell layout using a yield optimization model provided in advance,
wherein the predefined criterion is a process and device-friendly design condition in which semiconductor manufacturing process characteristics and device characteristics are taken into account, and
the cell layout generator generates a yield-optimized cell layout satisfying a preset target yield by changing the cell layout according to the optimization parameter derived from the optimization engine.

6. The cell layout generation device of claim 5, wherein a process is repeatedly performed until the yield-optimized cell layout is generated, the process comprising:
deriving, by the optimization engine, a new optimization parameter based on a yield of changed cell layout according to the optimization parameter, and
generating, by the cell layout generator, a new cell layout by changing the cell layout according to the new optimization parameter.

7. The cell layout generation device of claim 6, wherein the optimization engine derives the optimization parameter in which yield optimization is taken into account together with at least one predefined design optimization objective, and derives the optimization parameter in which an impact on each element of performance, power consumption, and area is taken into account.

8. An integrated circuit design system comprising:
a cell layout generation device comprising:
a cell layout generator configured to determine a placement corresponding to at least one transistor according to a predefined criterion based on data input to generate a cell layout and generate a cell layout by determining a routing corresponding to the placement, and
an optimization engine configured to derive an optimization parameter for a yield of the cell layout using a yield optimization model provided in advance, and configured to generate a high-yield cell library; and
a verification device configured to verify a yield improvement by the high-yield cell library generated by the cell layout generation device,
wherein the predefined criterion is a process and device-friendly design condition in which semiconductor manufacturing process characteristics and device characteristics are taken into account.

9. The integrated circuit design system of claim 8, wherein the verification device comprises:
a placement and routing (P&R) module configured to select, place, and route at least one cell layout for integrated circuit design using a standard cell library to generate an original integrated circuit design; and
an engineering change order (ECO) module configured to generate a yield-optimized integrated circuit design by applying the high-yield cell library to the original integrated circuit design.

10. The integrated circuit design system of claim 9, wherein the verification device further comprises a multi-product wafer (MPW) module configured to verify the yield improvement by the high-yield cell library by comparing degrees of yield improvements between the original integrated circuit design and the yield-optimized integrated circuit design.

11. A method performed by a cell layout generation device for integrated circuit design, the method comprising:
determining a placement corresponding to at least one transistor according to a predefined criterion based on data input to generate at least one cell layout; and
generating the at least one cell layout by determining a routing corresponding to the placement,
wherein the predefined criterion is a process and device-friendly design condition in which semiconductor manufacturing process characteristics and device characteristics are taken into account.

12. The method of claim 11, wherein the semiconductor manufacturing process characteristics and the device characteristics satisfy a lithography process condition.

13. A method performed by a cell layout generation device for integrated circuit design, the method comprising:
a cell layout generation operation determining a placement corresponding to at least one transistor according to a predefined criterion based on data input to generate a cell layout, and generating a cell layout by determining a routing corresponding to the placement;
an optimization parameter derivation operation deriving an optimization parameter for a yield of the cell layout using a yield optimization model provided in advance; and
an optimization operation generating a yield-optimized cell layout satisfying a preset target yield by changing the cell layout according to the optimization parameter,
wherein the predefined criterion is a process and device-friendly design condition in which semiconductor manufacturing process characteristics and device characteristics are taken into account.

14. The method of claim 13, wherein the optimization operation comprises, until a yield-optimized cell layout that satisfies the preset target yield is generated, repeatedly performing a process comprising:
evaluating whether a yield of the cell layout satisfies the preset target yield;
deriving a new optimization parameter when the preset target yield is not satisfied; and
changing the cell layout again according to the new optimization parameter.

15. A method performed by an integrated circuit design system, the method comprising:
determining a placement corresponding to at least one transistor according to a predefined criterion based on data input to generate a cell layout, and generating a cell layout by determining a routing corresponding to the placement;
deriving an optimization parameter for a yield of the cell layout using a yield optimization model provided in advance;
generating a yield-optimized cell layout satisfying a preset target yield by changing the cell layout according to the optimization parameter;
constructing a high-yield cell library comprising the yield-optimized cell layout; and
verifying a yield improvement by the high-yield cell library,
wherein the predefined criterion is a process and device-friendly design condition in which semiconductor manufacturing process characteristics and device characteristics are taken into account.
